(19) United States
(12) Patent Application Publication
(10) Pub. No.: US 2026/0296796 A1
(43) Pub. Date: Oct. 1, 2026

(54) TRANSPORT SYSTEM, MANUFACTURING SYSTEM, CONTROL METHOD, MANUFACTURING METHOD, AND STORAGE MEDIUM

(71) Applicant: CANON KABUSHIKI KAISHA, Tokyo (JP)

(72) Inventor: HIDETADA NARAHARA, Kanagawa (JP)

(21) Appl. No.: 19/564,961

(22) Filed: Mar. 12, 2026

(30) Foreign Application Priority Data
Mar. 27, 2025 (JP) 2025-054120

(51) Int. Cl. B65G 43/00; B65G 54/02

(52) U.S. Cl. CPC B65G 43/00; B65G 54/02

(57) ABSTRACT

A transport system includes a mover, a transport unit including a plurality of transport modules, a detection unit configured to detect a human approach the transport system, and a control unit. The control unit is configured to control the mover along the transport unit and set a velocity of the mover for each of the plurality of transport modules. The control unit changes the velocity of the mover on at least one of the plurality of transport modules in response to a signal input from the detection unit.

### BACKGROUND

### Field of the Technology

The present disclosure relates to a transport system, a manufacturing system, a control method, a manufacturing method, and a storage medium.

### Description of the Related Art

Generally, transport systems are used in production lines for assembling industrial products. Especially, in factory-automated production lines, transport systems are used to transport workpieces such as components within a production line or between production lines. Further, transport systems are sometimes used as transport devices within process apparatuses. As such a transport system, a transport system using a movable magnet-type or movable coil-type linear motor has already been proposed (Japanese Patent Laid-Open No. 2018-158723).

Further, in recent years, there have also been proposed various kinds of techniques for allowing work using various kinds of process apparatuses and work operated by a human to coexist in production lines.

When a transport system as described in Japanese Patent Laid-Open No. 2018-158723 is applied to a production line involving work by a human, consideration should be taken to prevent the transport system from inflicting harm on the human. On the other hand, operating the transport system at a safe velocity may undesirably lead to a reduction in the efficiency of the production line.

### SUMMARY

According to an aspect of the present disclosure, a transport system includes a mover, a transport unit including a plurality of transport modules, a control unit configured to control the mover along the transport unit, a detection unit configured to detect human approach to the transport system, and a setting unit configured to set a velocity of the mover for each of the plurality of transport modules. The setting unit changes the velocity of the mover on at least one of the plurality of transport modules in response to a signal input from the detection unit.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram of a transport system according to a first embodiment of the present disclosure.

FIGS. 2A to 2C are schematic configuration diagrams of a transport apparatus according to the first embodiment of the present disclosure.

FIG. 3 illustrates an operation of the transport system according to the first embodiment of the present disclosure.

FIGS. 4A to 4C illustrate an operation of a carriage according to the first embodiment of the present disclosure.

FIGS. 5A to 5C illustrate an operation of a carriage according to the first embodiment of the present disclosure.

FIGS. 6A to 6C illustrate an operation of a carriage according to the first embodiment of the present disclosure.

FIG. 7 is a schematic configuration diagram of a transport apparatus according to a second embodiment of the present disclosure.

FIG. 8 is a schematic configuration diagram of a transport apparatus according to a third embodiment of the present disclosure.

FIG. 9 is a schematic configuration diagram of a transport apparatus according to the third embodiment of the present disclosure.

FIGS. 10A to 10C illustrate an operation of a carriage according to a fourth embodiment of the present disclosure.

FIGS. 11A to 11C illustrate an operation of a carriage according to a fifth embodiment of the present disclosure.

FIG. 12 illustrates an operation of a transport system according to the fifth embodiment of the present disclosure.

### DESCRIPTION OF THE EMBODIMENTS

### First Embodiment

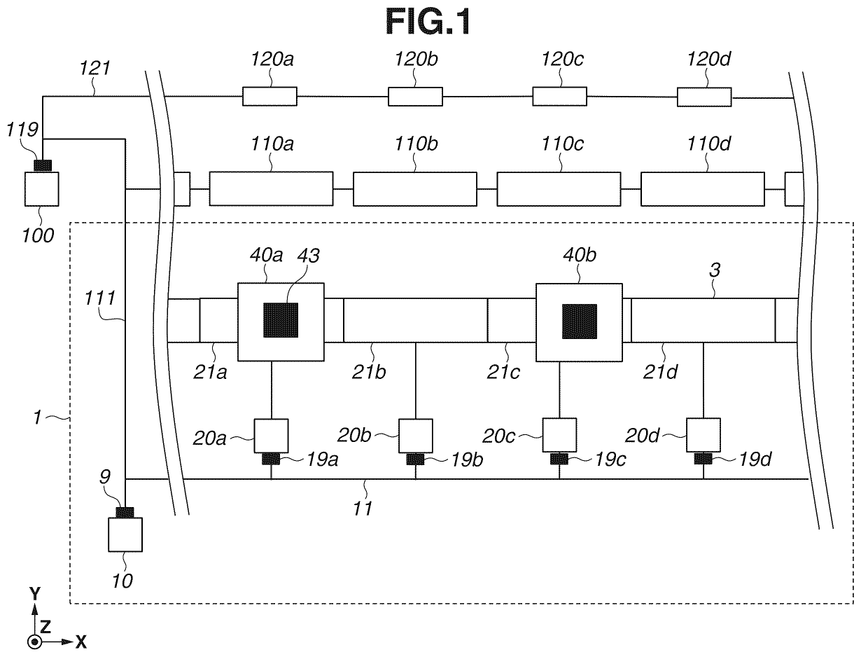

In the following description, a first embodiment will be described using FIGS. 1 to 6C with reference to the drawings. In the following description, for multiple components, individuals will be assigned with lowercase alphabets subsequent to reference numerals thereof to make the individuals distinguishable as needed, or will be indicated with only reference numerals common among them unless such distinction is especially needed.

A transport system 1 according to the present embodiment will be described with reference to FIG. 1. FIG. 1 is a schematic diagram illustrating a part of the transport system 1 including a transport unit 3, a carriage 40, a lower-level control unit 20, an upper-level control unit 10, and the like. In FIGS. 1 to 6C, an X axis is set along a direction in which the carriage 40 is transported, a Z axis is set to a direction vertical to a platform on which the transport module 21 is placed, and a Y axis is set to an axis orthogonal to the X axis and the Z axis. As will be used herein, this coordinate system may be referred to as a global coordinate system.

The transport system 1 includes the transport unit 3, which includes a plurality of transport modules 21 disposed on the platform while being coupled with each other, and a plurality of lower-level control units 20, which is connected to the plurality of transport modules 21 and controls the transport modules 21 to which they are connected. The plurality of transport modules 21 each include a stator equipped with a coil, which will be described below, and the carriage 40 includes a mover equipped with a permanent magnet, which will be described below. In other words, the transport system 1 according to the present embodiment is configured as a movable magnet type.

Further, the transport system 1 includes the upper-level control unit 10, which controls the plurality of lower-level control units 20 via a transport network 11, and a plurality of carriages 40 each carrying a workpiece 43 on the transport unit 3.

The plurality of lower-level control units 20 is each equipped with a lower-level external communication interface 19, and is communicably connected to the upper-level control unit 10 including an upper-level external communication interface 9 via the transport network 11. The lower-level control units 20 are each in charge of control of the transport module 21 to which they are connected, and control driving of the carriages 40 present on or entering their respective assigned transport modules 21 based on a driving instruction transmitted from the upper-level control unit 10.

The division of control responsibilities between the upper-level control unit 10 and the lower-level control units 20 is not limited thereto, and, for example, may be defined in such a manner that the upper-level control unit 10 is in charge of a calculation regarding the control and notifies the lower-level control units 20 of only necessary current values.

The transport system 1 is used together with a plurality of process apparatuses 110a to 110d, and the plurality of carriages 40 move along the transport unit 3 by receiving motive power from the transport modules 21 to carry the processing targets (workpieces) 43 to the respective process apparatuses 110. An apparatus control unit 100 includes an apparatus external communication interface 119, and the process apparatuses 110a to 110d are connected to each other by a process apparatus network 111 and controlled by the apparatus control unit 100. The apparatus control unit 100 is also connected to the upper-level control unit 10 via the apparatus external communication interface 119, and mutually exchanges information.

The transport unit 3 illustrated in FIG. 1 is described extracting only four transport modules 21a to 21d and lower-level control units 20a to 20d, and two carriages 40a and 40b for simplification of the description. The numbers of the transport modules 21, lower-level control units 20, and carriages 40 are not limited to these examples. For example, the transport unit 3 may be configured to have a circulation route in combination with a transport module for transporting the carriage 40 in the Y direction in FIG. 1.

In the following description, assume that the plurality of process apparatuses 110a to 110d and the plurality of transport modules 21a to 21d are arranged in correspondence with each other, respectively, for simplification of the description. For example, the process apparatus 110a performs a process on the carriage 40a present on the transport module 21a.

An intrusion detection unit 120 is appropriately installed to detect human intrusion. The intrusion detection unit 120 may be, for example, an area sensor, a laser scanner, or a laser curtain, but is not limited thereto as long as the intrusion detection unit 120 can detect human intrusion and may be realized by any method using a known technique.

A plurality of intrusion detection units 120 (120a to 120d) is communicably connected to the apparatus control unit 100 via a sensor network 121 and the apparatus external communication interface 119. A General Purpose input/output (GPIO) may be used for the sensor network 121. Alternatively, field bus communication that handles digital data may also be used.

The intrusion detection units 120a to 120d are disposed in an arrangement corresponding to the plurality of process apparatuses 110a to 110d or the plurality of transport modules 21a to 21d.

In the apparatus control unit 100, a combination of the intrusion detection unit 120, the process apparatus 110, and the transport module 21 is preset to segment a target section to be switched to a safe operation as an apparatus.

The target section corresponding to the intrusion detection unit 120b that is switched to the safe operation can be set as a predetermined range around a mechanical apparatus in motion such as the process apparatus 110b and the transport module 21b. Alternatively, the target section may also be set as another arbitrary section.

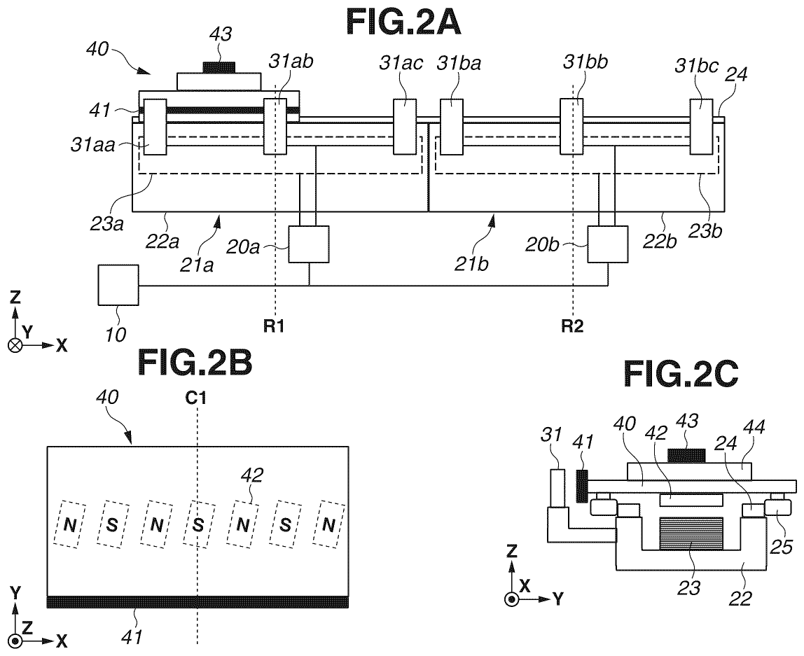

FIGS. 2A to 2C illustrate the two transport modules 21a and 21b and one carriage 40. The configuration of the transport module 21 and the carriage 40 will be described in further detail with reference to FIGS. 2A to 2C.

FIG. 2A illustrates one carriage 40 and two transport modules 21a and 21b as viewed from the Y-axis direction. FIG. 2B illustrates only the carriage 40 as viewed from the Z-axis direction. FIG. 2C illustrates the transport module 21a and the carriage 40 as viewed from the X-axis direction.

As illustrated in FIGS. 2A and 2C, the transport module 21a includes a housing 22a, encoders 31aa to 31ac, a coil group 23a, and guide rails 24, and the transport module 21a is connected to the lower-level control unit 20a. Further, the transport module 21b includes a housing 22b, encoders 31ba to 31bc, a coil group 23b, and the guide rails 24, and is connected to the lower-level control unit 20b. The present embodiment indicates an example using the encoders 31aa to 31bc, but is not limited thereto. As long as the position of the carriage 40 can be detected, any known sensor can be used.

As will be used herein, the encoders 31a to 31c may be referred to as sensors 31a to 31c. The lower-level control unit 20a is connected with a not-illustrated power source. The number and the installation positions of the encoders 31aa to 31ac in the transport module 21a are adjusted as appropriate depending on the sizes of the carriage 40 and the transport module 21a, the accuracy of the detection of the position of the carriage 40, and the like. The guide rails 24 may also be used in common between the housings 22a and 22b. Other transport modules 21 are also configured in a similar manner.

As illustrated in FIGS. 2B and 2C, the carriage 40 includes a scale 41, a plurality of permanent magnets 42 (may be referred to as a magnet array), a workpiece holding mechanism 44, and guide rollers 25.

The guide rollers 25 in this case may be configured in any manner capable of moving the carriage 40 in the X-axis direction, and the guide rollers 25 may also be configured as guide blocks.

The guide rollers 25 of the carriage 40 are guided by the guide rails 24 of the transport module 21, and the carriage 40 is driven by an electromagnetic force generated between the carriage 40 and the coil group 23 mounted on the housing 22, and the carriage 40 is transported along the transport unit 3 (the X axis).

For example, encoders 31a to 31c of the transport module 21a are installed at a plurality of positions of the housing 22a so as to maintain a constant gap between the scale 41 of the carriage 40 and the encoders.

The encoders 31a to 31c are installed at appropriate intervals so as to be able to detect the carriage 40 regardless of at which position the carriage 40 is located on the transport module 21a.

The encoders 31a to 31c read a pattern of the scale 41 of the carriage 40 and detect the position of the carriage 40 in the X direction (an X position) as a relative position from the encoders 31a to 31c. The encoders 31a to 31c then output information regarding the position of the carriage 40a to the lower-level control unit 20a, and the lower-level control unit 20a can detect at which position the carriage 40 is located on its assigned transport module 21a based on this information. The lower-level control unit 20a transmits this information to the upper-level control unit 10.

The present embodiment indicates an example in which the encoder 31 is an absolute type, and the scale 41 can be read by an absolute-type sensor, but is not limited thereto.

For example, a center C1 of the width of the carriage 40 in the carriage transport direction (X direction) is determined to be a reference position, and the position of the carriage 40 is defined as a coordinate of the reference position C1.

The upper-level control unit 10 controls the entire transport system 1 using one coordinate system (the above-described global coordinate system) in the control of the carriage 40. On the other hand, the lower-level control units 20a and 20b perform control using an individual coordinate system (referred to as a local coordinate system) set to each of the lower-level control units 20a and 20b.

For example, the position of an encoder located at the center of the transport module, among the sensors mounted on each transport module that transmits a signal to each lower-level control unit, is determined to be an origin point of the local coordinate system of the corresponding transport module.

A position R1 is the position of the encoder 31ab in the global coordinate system, and the position R1 is the origin point of the transport module 21a. Similarly, a position R2 is the position of the encoder 31bb in the global coordinate system, and the position R2 is the origin point of the transport module 21b.

The upper-level control unit 10 holds the position of the origin point in the local coordinate system of each transport module. The lower-level control unit 20 applies a current to the coil group 23 of the transport module 21 assigned for the lower-level control unit 20 and controls a current amount of the coil group 23 based on a driving instruction from the upper-level control unit 10. The lower-level control unit 20 thereby transports the carriage 40 to or stops the carriage 40 at a predetermined position at a predetermined velocity on the transport module 21 assigned for the lower-level control unit 20.

The lower-level control unit 20 can also detect that the carriage 40 has entered from an adjacent transport module 21 to the transport module 21 assigned for the lower-level control unit 20 by using the encoders 31aa to 31bc of the transport module 21 assigned for the lower-level control unit 20. After the entering carriage 40 has reached a predetermined position of the transport module 21 assigned for the lower-level control unit 20, the lower-level control unit 20 controls the transport of the carriage 40 based on a control instruction from the upper-level control unit 10.

The predetermined position may be a boundary between the transport modules 21. The lower-level control unit 20 may also be configured to control the carriage 40 when the encoder 31 of the transport module 21 assigned for the lower-level control unit 20 reads the scale 41 of the carriage 40.

For example, assuming that the carriage 40 moves in the X-axis positive direction in FIG. 2A, the lower-level control unit 20a controls the carriage 40 on the transport module 21a when the sensor 31aa of the transport module 21a reads the scale 41 of the carriage 40. Further, the lower-level control unit 20b controls the carriage 40 on the transport module 21b when the carriage 40 enters the transport module 21b and the sensor 31ba of the transport module 21b reads the scale 41 of the carriage 40.

Upon receiving the driving instruction from the upper-level control unit 10, the plurality of lower-level control units 20 each applies the driving instruction to the carriage 40 present on or entering the transport module 21 assigned for the lower-level control unit 20 to start controlling the driving of the carriage 40.

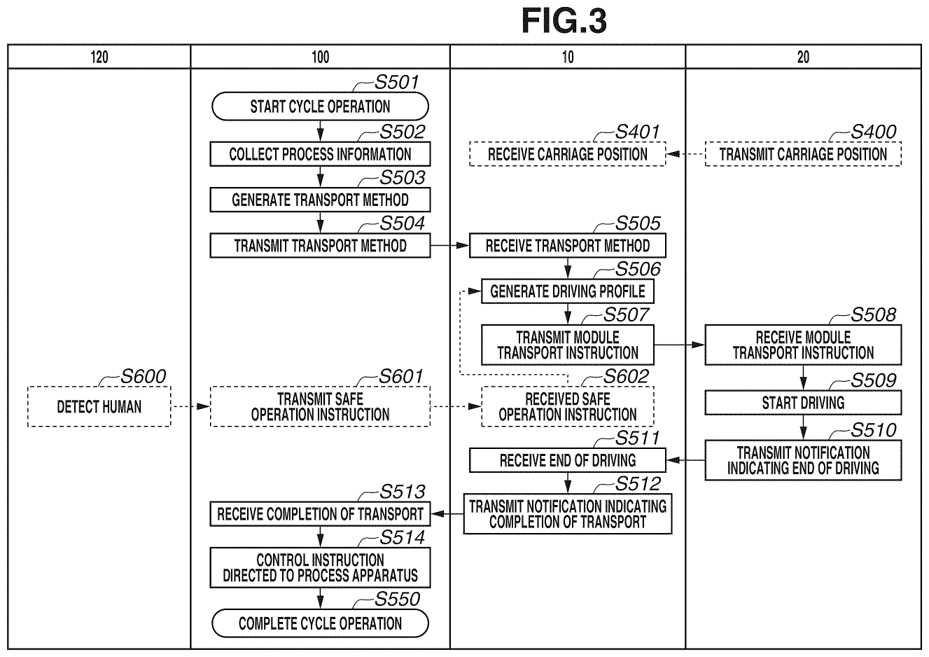

FIG. 3 is a timing chart of the operation among the apparatus control unit 100, the upper-level control unit 10, and the lower-level control unit 20.

Generally, a manufacturing process of industrial products is arranged to transport a plurality of workpieces 43 on the transport unit 3, and sequentially process the workpieces 43 by the plurality of process apparatuses 110 lined up in the process order along the transport unit 3 at the same time. It is assumed that a work unit of the transport of the workpiece 43 and the processing by the process apparatus will be referred to as a “cycle operation”, and a product is manufactured by repeating such a cycle operation.

Another step that works asynchronously with a main sequence will now be described. In step S400, the lower-level control unit 20 constantly acquires the carriage position from the encoder 31 and transmits the carriage position to the upper-level control unit 10. In step S401, the upper-level control unit 10 constantly converts the position for each carriage into the global coordinate system to hold and update the position.

The main sequence will now be described. First, in step S501, the cycle operation is started. Upon this start, in step S502, the apparatus control unit 100 collects process information regarding statuses of the workpiece 43 on each carriage 40 and the process apparatus 110. In step S503, the apparatus control unit 100 generates a carriage transport method according to the collected process information.

For example, when an insufficiently processed workpiece is present among the workpieces 43 on the carriage group constituted by the plurality of carriages 40, this workpiece is transported to a process where the workpiece is supposed to be processed additionally. Alternatively, for example, a workpiece may be transported to a process for the purpose of collection, and therefore the method for transporting the carriage 40 is reviewed for each cycle operation. In step S504, the apparatus control unit 100 transmits the method for transporting the carriage group constituted by the plurality of carriages 40 to the upper-level control unit 10.

In step S505, the upper-level control unit 10 receives the method for transporting the carriage group.

In step S506, the upper-level control unit 10 generates a trapezoidal driving profile for each carriage 40 by using the position information for each carriage 40 acquired in step S401, based on the method for transporting the carriage group.

In step S507, the upper-level control unit 10 transmits the driving profile to the corresponding lower-level control unit 20 as a module transport instruction based on the position information for each carriage 40 acquired in step S401.

In step S508, the lower-level control unit 20 receives the driving instruction.

In step S509, each lower-level control unit 20 starts controlling the driving of the carriage 40. The lower-level control unit 20, for example, starts transporting the carriage 40 present on the transport module 21 assigned for the lower-level control unit 20, or transports or stops the carriage 40 by applying the trapezoidal driving profile to the entering carriage 40.

In step S510, each of the lower-level control units 20 transmits a driving end signal to the upper-level control unit 10 after completing the application of the entire trapezoidal driving profile according to the driving instruction transmitted from the upper-level control unit 10. In step S511, the upper-level control unit 10 receives the driving end signal from each of the lower-level control units 20. In step S512, the upper-level control unit 10 transmits a notification indicating the completion of the transport to the apparatus control unit 100.

The upper-level control unit 10 continues transmitting the module transport instruction until the driving of the corresponding carriage 40 is ended in step S507 as necessary, until the driving end signal is received in step S511.

In step S513, the apparatus control unit 100 receives the notification indicating the completion of the transport from the upper-level control unit 10. In step S514, the apparatus control unit 100 transmits a control instruction to the process apparatus 110 to cause the process apparatus 110 to process the workpiece 43. In step S550, one cycle operation is completed in such a manner. After one cycle operation is completed, the apparatus control unit 100 starts a next cycle operation from steps S501 to S550.

Next, a case will be described where a human approaches the transport system 1 at the time of this cycle operation. When a human approaches the transport system 1, the corresponding intrusion detection unit 120 transmits, in step S600, the human detection state to the apparatus control unit 100 via the apparatus external communication interface 119.

In step S601, the apparatus control unit 100 transmits an instruction serving to trigger a safe operation in response to the detection state of the intrusion detection unit 120 to the upper-level control unit 10 via the upper-level external communication interface 9. Information regarding the safe operation instruction at this time is, for example, bit information representing ON or OFF of the execution of the safe operation, or information regarding a target velocity, acceleration and deceleration for achieving the safe operation, and the transport module 21 set as the safe operation target. The bit information indicating the execution of the safe operation includes a safe stop signal, and may be referred to as a safe operation instruction or a safe stop instruction.

In step S602, the upper-level control unit 10 receives the safe operation instruction transmitted from the apparatus control unit 100 and hands over this safe operation instruction to step S506. In step S506, the driving profile is thereby generated according to the received safe operation instruction again.

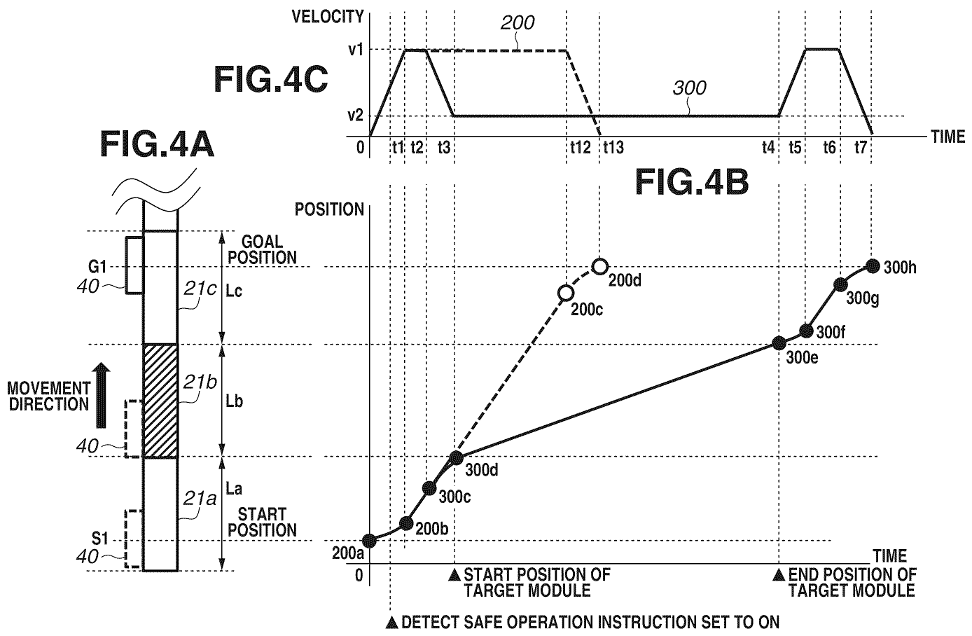

Next, the generation of the driving profile according to the above-described safe operation instruction will be described in detail with reference to FIGS. 4A to 4C.

First, a method for transporting one carriage 40 across a plurality of transport modules 21 will be described. FIG. 4A is a schematic configuration diagram illustrating that one carriage 40 is transported across the three transport modules 21a to 21c. FIG. 4B illustrates the driving profile of the carriage 40 with the vertical axis representing the X position of the carriage 40 and the horizontal axis representing time t. FIG. 4C illustrates a velocity profile of the carriage 40 with the vertical axis representing a velocity v of the carriage 40 and the horizontal axis representing time t.

The transport module 21b illustrated in FIG. 4A is a transport module 21 set as the safe operation target, which is a target where the carriage 40 is transported at a safe velocity, by the upper-level control unit 10.

A driving profile 200 is a driving profile for moving the carriage 40 from a start position S1 to a goal position G1 at a first velocity v1 according to trapezoidal driving. The driving profile 200 includes driving profiles 200a to 200d, and coordinate values are defined on the global coordinate system X.

The acceleration and deceleration will be described based on a trapezoidal profile in the present embodiment for simplification of the description, but are not limited thereto. An S-curve profile using an acceleration may be used or another known profile may also be used.

The driving profile 200 is generated by the upper-level control unit 10. In the present configuration, the lower-level control units 20a to 20c connected to the three transport modules 21a to 21c are involved in the control of the transport of the carriage 40. Thus, in consideration of module lengths La to Lc of the corresponding transport modules 21a to 21c, the upper-level control unit 10 issues an instruction using the driving profile 200 in the relative coordinate systems corresponding thereto, respectively.

The present embodiment indicates an example in which the upper-level control unit 10 converts the driving profile 200 into the relative coordinate system for the lower-level control unit 20 and transmits the instruction, but is not limited thereto. For example, the driving profile 200 may be any profile allowing the lower-level control unit 20 to control the carriage 40 according to the driving profile 200 generated by the upper-level control unit 10.

Next, a driving profile 300 will be described. The driving profile 300 includes driving profiles 200a, 200b, 300c, 300d, 300e, 300f, 300g, and 300h.

The driving profile 300 is a driving profile regarding driving from a start to an end of a movement of the carriage 40 when the upper-level control unit 10 receives the safe operation instruction set to ON from the apparatus control unit 100 while the carriage 40 is moving on the transport module 21a.

A second velocity v2 at this time is a transport velocity capable of achieving the safe operation, and a function as a setting unit that sets such velocity may be the upper-level control unit 10 or may be the apparatus control unit 100. The present embodiment will be described assuming that the safe operation is performed using the velocity received from the apparatus control unit 100. Further, assume that this also applies to an acceleration and a deceleration.

The carriage 40 is transported at a first velocity v1 using the conventional driving profile 200 while the carriage 40 is transported on the transport module 21a not targeted for the safe operation instruction.

However, the next transport module 21b is the transport module targeted for the safe operation instruction, and thus the carriage 40 should be decelerated to up to the transport velocity of the second velocity v2 by the time before the carriage 40 reaches the transport module 21b.

Assuming that t3 is a time when the carriage 40 enters the transport module 21b, the deceleration operation is started since t2 based on the deceleration received from the apparatus control unit 100.

When the carriage 40 is transported on the transport module 21b according to the driving profile 300, the driving profile 300 is kept applied while the carriage 40 is transported on the target transport module 21b unless an instruction to release the safe operation instruction is issued from the apparatus control unit 100.

Thereafter, the carriage 40 is accelerated again to the first velocity v1, which is the conventional velocity, at time t4 when the carriage 40 passes through the transport module 21b and enters the transport module 21c, until time t5.

Due to the above-described operation, the carriage 40 can be transported based on the safe operation instruction.

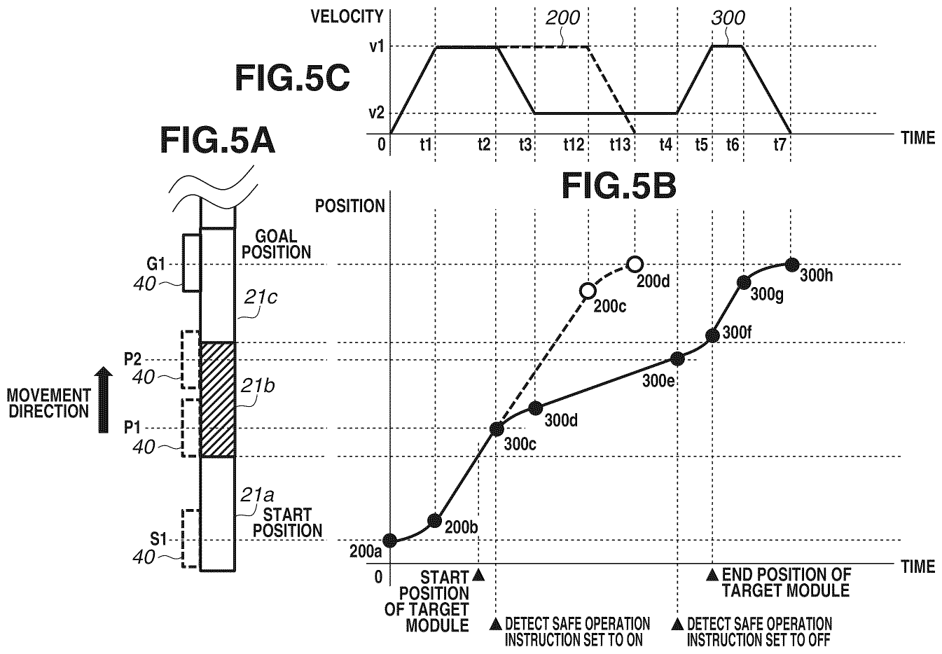

Next, a driving profile when the instruction is received at a timing different from the timing illustrated in FIGS. 4A to 4C will be described with reference to FIGS. 5A to 5C.

FIGS. 5A to 5C are different from FIGS. 4A to 4C in that, while the carriage 40 passes through the transport module 21b, the upper-level control unit 10 receives the safe operation instruction set to ON from the apparatus control unit 100, and the safe operation instruction transitions to an OFF state immediately thereafter.

The carriage 40 in FIG. 5A departs S1 and heads to G1, and the carriage 40 is transported according to the driving profile 200.

P1 represents a carriage position when the upper-level control unit 10 detects the safe operation instruction set to ON from the apparatus control unit 100. This time corresponds to time t2.

Because the transport module 21b is set as the module targeted for the safe operation when the carriage 40 is located at P1, the driving profile is changed according to the safe operation instruction.

FIG. 5C illustrates that the driving profile is changed to a profile for deceleration so as to slow down the carriage 40 to the second velocity v2, which is the safe transport velocity, at time t2 when the safe operation instruction set to ON is detected, and the transport velocity reaches the second velocity v2 at time t3 as indicated by the driving profiles 300c and 300d.

The carriage 40 is transported at the second velocity v2 on the transport module 21b according to the instruction of the driving profiles 300d and 300e while the safe operation instruction is kept to ON thereafter.

P2 represents a carriage position when the upper-level control unit 10 detects the safe operation instruction set to OFF from the apparatus control unit 100. This time corresponds to time t4.

The driving profile 300 of the carriage 40 after the safe operation instruction is switched to OFF accelerates the carriage 40 at an acceleration specified in the safe operation instruction until time t5 as indicated by driving profiles 300e and 300f. Thereafter, the carriage 40 is transported at the normal first velocity v1, and is then stopped at time t7.

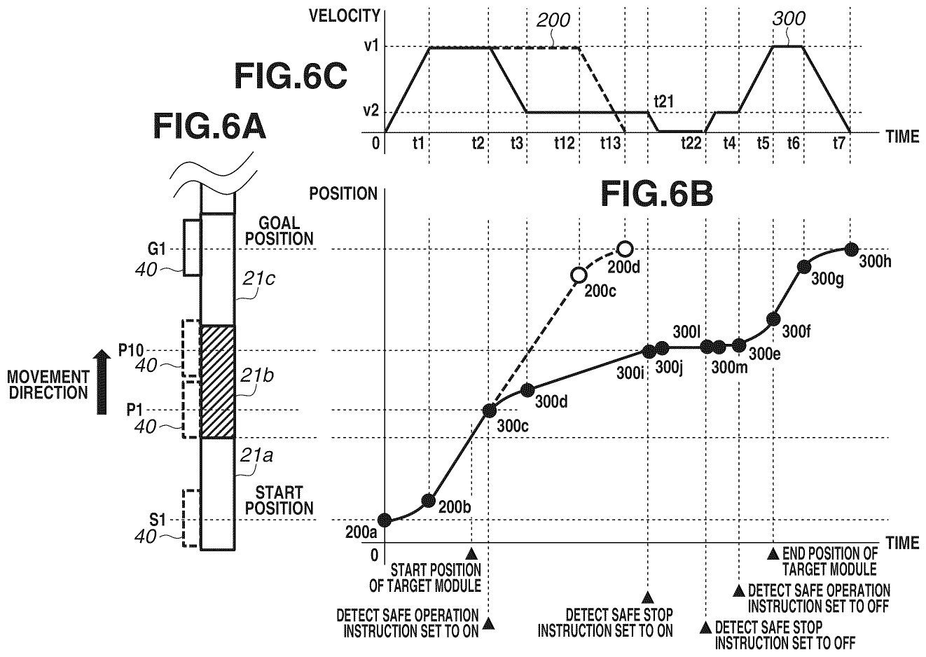

Next, a profile including a stop by the intrusion detection unit 120 will be described with reference to FIGS. 6A to 6C.

FIGS. 6A to 6C are different from FIGS. 5A to 5C in that the safe stop signal is switched to ON when human intrusion is further detected by the intrusion detection unit 120 after the upper-level control unit 10 receives the safe operation instruction set to ON from the apparatus control unit 100 while the carriage 40 passes through the transport module 21b.

In the following description, assume that the intrusion detection unit 120 is, for example, a laser scanner capable of measuring a distance to a human. The intrusion detection unit 120 transmits data to the apparatus control unit 100 in digital data or the like. The apparatus control unit 100 presets a plurality of threshold values therein.

The plurality of threshold values is associated with the safe operation instruction or the safe stop signal, and, for example, the safe operation instruction is switched to ON when a distance between a human and the transport system 1 falls below a distance of 3 m and is switched to OFF when a human is located farther than the distance of 3 m.

Similarly, when a human is located within a range where the human may be exposed to danger, such as within 1 m, the safe stop signal is switched to ON to stop the transport system 1 for safety. The safe stop signal is switched to OFF when the human leaves this range.

The velocity is assumed to be switched among three levels, namely, the first velocity v1, which is the normal transport velocity, the second velocity v2, and the stop in the present example for simplification of the description, but is not limited thereto. The number of levels among which the velocity is switched is not especially limited as long as the transport velocity is set to decrease according to human approach to the transport system 1.

The safe operation instruction and the safe stop instruction are transmitted from the apparatus control unit 100 to the upper-level control unit 10.

The time at which the carriage 40 is located at P10 in FIG. 6A corresponds to time t21 in FIG. 6C. FIGS. 6A to 6C indicate that the upper-level control unit 10 detects the above-described safe stop signal set to ON at time t21.

At time t21, the driving profile 300 draws a velocity profile for deceleration, and the carriage 40 moves as indicated by driving profiles 300i to 300j.

Time t22 in the driving profile 300 indicates a timing when the safe stop signal is switched to OFF. The carriage 40 is kept stopped there until that timing.

After the safe stop signal is switched to OFF, the driving profile 300 draws an acceleration profile, and the carriage 40 moves as indicated by driving profiles 3001 to 300m in the driving profile 300.

Thereafter, the carriage 40 is transported at the second velocity v2 until the safe operation signal is switched to OFF.

The above-described makes the carriage 40 to be transported while the velocity is switched to the safe transport velocity. Alternatively, the carriage 40 can be stopped. The timings described with reference to FIGS. 4A to 4C, 5A to 5C, or 6A to 6C are merely examples, and may be employed in combination. Further, the driving profile does not necessarily be a trapezoidal driving profile, and may become a triangular driving profile as a result in a case of a short distance even when a trapezoidal driving profile is employed. Alternatively, another driving profile may be used. Further, the acceleration and the deceleration neither necessarily have to be the same between the driving profile 200 and the driving profile 300, and respective appropriate settings may be used.

In this manner, detecting human intrusion and notifying the transport system 1 thereof as the safe operation instruction and the safe stop instruction allows the velocity to be changed to the safe operation velocity in the target range, thereby being able to suppress a decrease in the production efficiency while taking human safety into consideration.

Further, the transport system 1 may be configured in such a manner that the input of the detection state of the intrusion detection unit 120 is directly input to the upper-level control unit 10 via the upper-level external communication interface 9, provided that the transport module 21 targeted for the safe operation, the second velocity v2, and the like are preset in the upper-level control unit 10.

Further, similarly, the transport system 1 may be configured in such a manner that the input of the detection state of the intrusion detection unit 120 is directly input to the lower-level control unit 20 via the lower-level external communication interface 19, provided that the second velocity v2 and the like are preset in the lower-level control unit 20. In this case, the transport system 1 may be configured to allow the upper-level control unit 10 to change the driving profile by notifying the upper-level control unit 10 of the detection state from the lower-level control unit 20.

### Second Embodiment

A transport system according to a second embodiment of the present disclosure will now be described. The second embodiment will be described, assigning the same reference numerals to similar components to the above-described first embodiment, omitting the descriptions thereof as appropriate.

The transport system 1 according to the present embodiment is different from the transport system 1 according to the first embodiment in that a range affected by the safe operation instruction can be set to an arbitrary position.

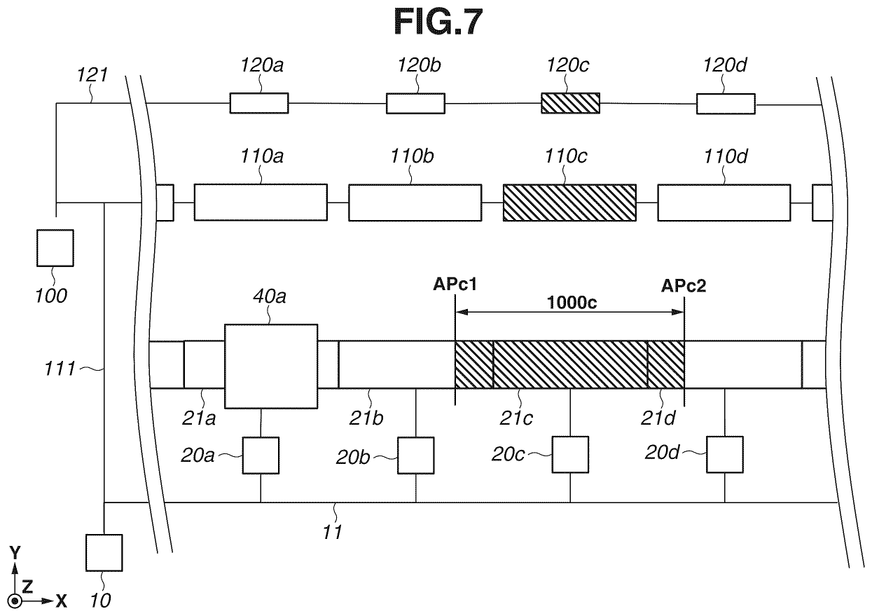

In the following description, the second embodiment of the present disclosure will be described with reference to FIG. 7.

The range affected by the safe operation instruction according to the present embodiment will be described with reference to FIG. 7. In addition to the segmentation of the target section to switch the transport module 21 to the safe operation according to the first embodiment, an effective safe operation range in the global coordinate system is preset in the upper-level control unit 10.

A safe operation range 1000 is a range set to an arbitrary position regardless of the length of the transport module 21.

For example, a safe operation range 1000c is indicated by an external range of APc1 to APc2 extending beyond the length of the transport module 21c. Assume that APc1 to APc2 is preset by the apparatus control unit 100.

Next, an example of the setting content of the safe operation range 1000c will be described. APc1 and APc2 may be set as an offset amount such as +100 mm from the length of the transport module 21. Alternatively, an arbitrary range in the global coordinate system may also be set in advance.

The apparatus control unit 100 presets the intrusion detection unit 120c in association with the process apparatus 100c and the safe operation range 1000c. Thus, when the intrusion detection unit 120c detects human or object intrusion, the safe operation instruction is transmitted from the apparatus control unit 100 to the upper-level control unit 10 similarly to the first embodiment. Alternatively, in a case where the process apparatus 110c is equipped with an intrusion detection function, a result of this detection may be used instead of the intrusion detection unit 120c.

In step S601 according to the present embodiment, the information regarding the safe operation instruction includes information about the above-described safe operation range 1000 and the like.

In step S602, the upper-level control unit 10 receives the safe operation instruction transmitted from the apparatus control unit 100, and hands over the safe operation instruction to step S506. At this time, in step S506, the driving profile is generated again according to the received safe operation instruction by using the information about the safe operation range 1000.

In this manner, according to the present embodiment, the safe operation range can be set to an arbitrary range regardless of the length of the transport module. The present embodiment indicates an example in which the safe operation range is a range wider than the corresponding transport module, but is not limited thereto.

For example, a range narrowed so as to specify a partial range on the transport module may be set. Alternatively, two or more transport modules including the corresponding module may be set in addition to the corresponding module, and, for example, a transport module adjacent to the corresponding transport module may be set. Further, safe operation ranges set for adjacent modules may overlap each other. Further, the apparatus control unit 100 may change the safe operation range each time in consideration of, for example, the operation range of the process apparatus 110, and transmit the safe operation range to the upper-level control unit 10 as the safe operation instruction. Due to such arrangement, the present embodiment can suppress a reduction in the production efficiency while taking human safety into consideration.

Further, the present embodiment has been described citing an example in which the apparatus control unit 100 presets the safe operation range 1000, but may be configured in such a manner that the upper-level control unit 10 presets the safe operation range 1000.

Further, provided that a unique identification (ID) is preset to each safe operation range 1000, the safe operation instruction may be issued from the apparatus control unit 100 by specifying the ID. Further, the transport system 1 may be configured to associate the intrusion detection unit 120 and the ID of the safe operation range, and allow an instruction regarding deceleration or stop to be issued to the safe operation range assigned with this ID in response to detection by the intrusion detection unit 120.

In the case where the intrusion detection unit 120 and the ID of the safe operation range are associated, the transport system 1 may be configured to associate one intrusion detection unit 120 and the IDs of a plurality of safe operation ranges, and allow an instruction regarding deceleration or stop to be issued to the plurality of safe operation ranges. Further, the transport system 1 may be configured to allow an instruction regarding deceleration or stop to be issued to the safe operation ranges assigned with the IDs based on simultaneous intrusion detection by a plurality of intrusion detection units 120.

Further, the present embodiment indicates an example in which the safe operation range 1000 is set as a part of the transport unit 3 in the above description, but is not limited thereto, and may be configured to allow the safe operation to be performed in the entire transport unit 3 based on detection by one intrusion detection unit 120, assuming that the safe operation range covers the entire transport unit 3. Setting the safe operation range 1000 as a part of the transport unit 3 allows the deceleration and stop to be applied only in a partial range to thus succeed in suppressing a reduction in the production efficiency, and setting the safe operation range 1000 as the entire transport unit 3 allows the transport system 1 to be further safely managed.

### Third Embodiment

A transport system according to a third embodiment of the present disclosure will now be described. The third embodiment will be described, assigning the same reference numerals to similar components to the above-described first embodiment, omitting the descriptions thereof as appropriate. The transport system 1 according to the present embodiment is different from the transport system 1 according to the first embodiment in that the operation target of the safe operation instruction is set using a setting table individually.

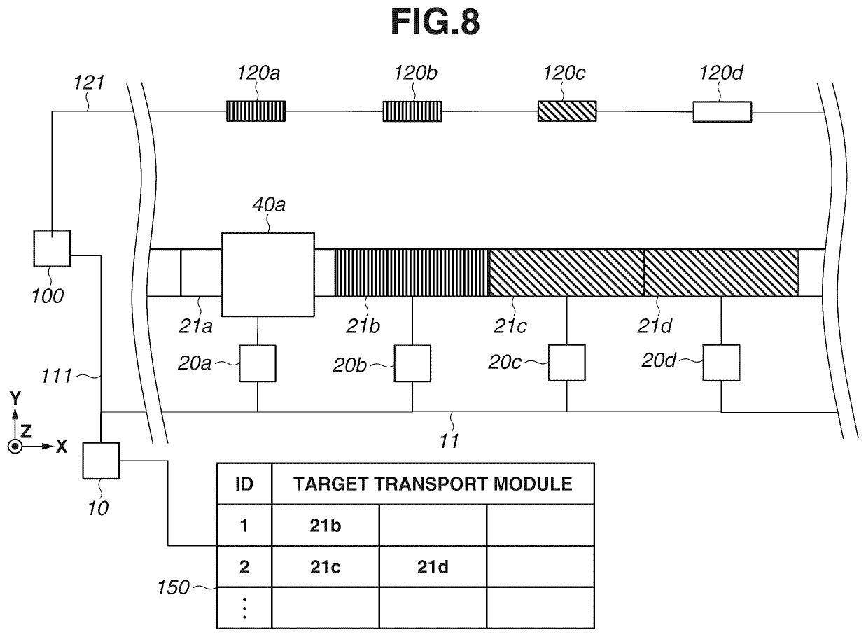

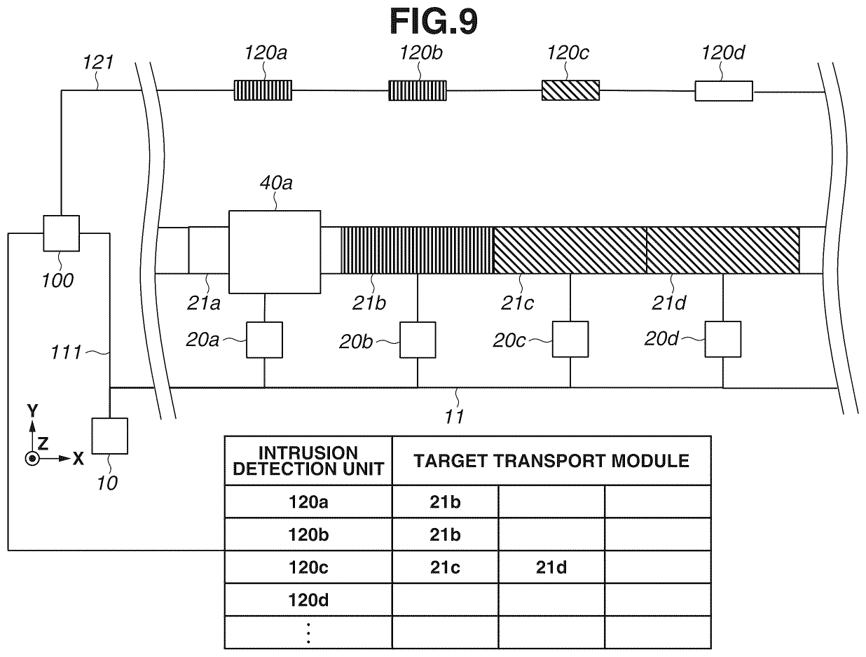

In the following description, the third embodiment of the present disclosure will be described with reference to FIGS. 8 and 9. First, a safe operation setting table according to the present embodiment will be described with reference to FIG. 8.

A safe operation setting table 150 illustrated in FIG. 8 is preset in the upper-level control unit 10. The safe operation setting table 150 indicates a setting table storing the relationship with the safe operation target transport module 21 using an ID as a key.

An ID 1 is associated with the transport module 21b. An ID 2 is associated with the transport module 21c and the transport module 21d.

The IDs and the transport modules 21 are listed in the setting table in association with each other in the above-described manner in the present embodiment, but such association may include an overlap.

For example, the transport module 21d may be specified in association with an ID 3, and the transport module associated with the ID 3 may overlap the transport module 21 listed in association with the ID 2.

The apparatus control unit 100 associates the intrusion detection unit 120 and the ID used in the safe operation setting table 150 in advance. For example, an action is taken on the ID 1 when the intrusion detection unit 120a or 120b detects intrusion. This association is merely an example, and the association between the intrusion detection unit 120 and the ID may be changed according to a situation.

The ID is included as one of the pieces of information in the safe operation instruction at the time of step S601 that is transmitted from the apparatus control unit 100. After receiving the safe operation instruction including the ID indicating the safe operation target in step S602, the upper-level control unit 10 hands over the information to the generation of the driving profile in step S506.

In the generation of the driving profile in step S506, the target transport module 21 is extracted using the ID as the key from the safe operation setting table 150 based on the acquired ID indicating the safe operation target.

If the carriage position acquired in step S401 is located on the transport module 21 extracted using the ID as the key, an operation similar to the above-described first embodiment is performed.

This can freely associate the intrusion detection unit 120 and the segmentation of the safe operation target.

In other words, the present embodiment allows the velocity to be changed to the safe operation velocity in an arbitrary range, thereby being able to suppress a decrease in the production efficiency while taking human safety into consideration.

Next, an example in a case where the apparatus control unit 100 includes the safe operation setting table 150 will be described with reference to FIG. 9. The safe operation setting table 150 illustrated in FIG. 9 is preset and is held by the apparatus control unit 100.

The safe operation setting table 150 indicates a setting table storing the relationship with the safe operation target transport module 21 using the intrusion detection unit 120 as a key.

The intrusion detection unit 120a and the intrusion detection unit 120b are associated with the transport module 21b. The intrusion detection unit 120c is associated with the transport module 21c and the transport module 21d.

The intrusion detection unit 120 and the transport module 21 are listed in the setting table in association with each other in the above-described manner in the present embodiment, but such association may include an overlap.

For example, the transport module 21d may be specified in association with the intrusion detection unit 120a, and the transport module associated with the intrusion detection unit 120a may overlap the transport module 21d listed in association with the intrusion detection unit 120c.

The apparatus control unit 100 extracts the target transport module from the safe operation setting table 150 based on the result of the detection by the intrusion detection unit 120. The apparatus control unit 100 transmits the extracted transport module as the information about the safe operation instruction at the time of step S601.

In this manner, according to the present embodiment, the intrusion detection unit 120 and the segmentation of the safe operation target can be freely associated. Due to that, the present embodiment allows the velocity to be changed to the safe operation velocity in an arbitrary range, thereby being able to suppress a decrease in the production efficiency while taking human safety into consideration.

### Fourth Embodiment

A transport system according to a fourth embodiment of the present disclosure will now be described. The fourth embodiment will be described, assigning the same reference numerals to similar components to the above-described first embodiment, omitting the descriptions thereof as appropriate. The transport system 1 according to the present embodiment is different from the transport system 1 according to the first embodiment in terms of the method for generating the driving profile.

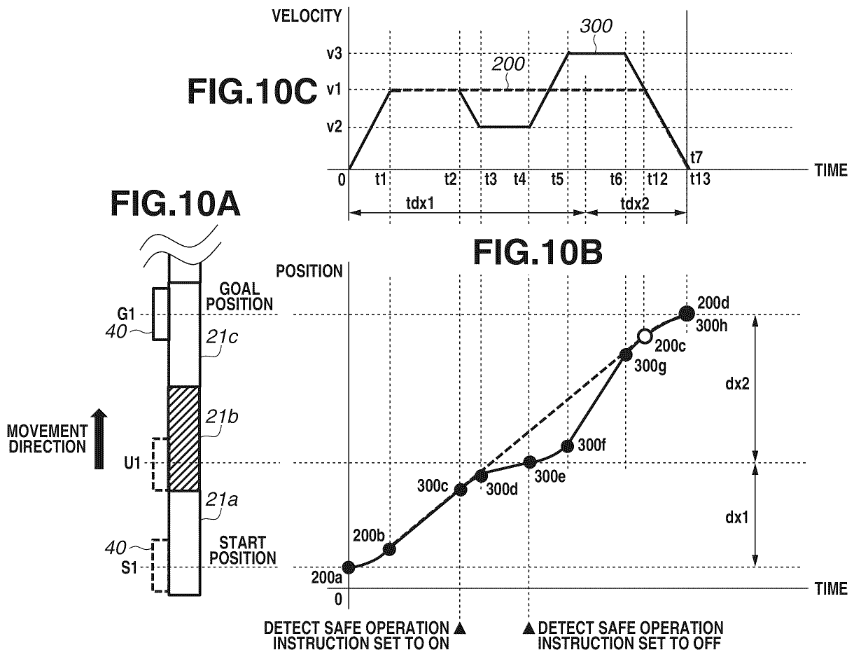

In the following description, the fourth embodiment of the present disclosure will be described with reference to FIGS. 10A to 10C. FIGS. 10A to 10C illustrate the driving profile 300 according to the present embodiment.

The driving profile 300 uses a third velocity v3 in addition to the first velocity v1 and the second velocity v2 according to the first embodiment. The third velocity v3 is handled as a velocity for transporting the carriage 40 at a higher velocity than the normal transport velocity v1 from the apparatus control unit 100.

In FIG. 10A, the carriage 40 departs from S1 and heads to the target goal position G1. The transport module 21b is specified as the safe operation target from the apparatus control unit 100 to the upper-level control unit 10.

The safe operation instruction is switched to ON at the position of the driving profile 300c in FIG. 10B and time t3 in FIG. 10C.

When the carriage 40 is located at a position U1 in FIG. 10A, the driving profile indicates the position of the driving profile 300e in FIG. 10B, and the safe operation instruction is switched to OFF at time t4 in FIG. 10C.

The present embodiment will be described regarding control for catching up with the transport time of the driving profile 200, according to which the carriage 40 is originally planned to be transported, after the safe operation instruction is switched to OFF at this time t4 in FIG. 10C.

The upper-level control unit 10, having received the transport instruction from the apparatus control unit 100, generates a driving profile applicable at the time of normal transport in the generation of the driving profile in step S506.

At this time, the carriage 40 receives the transport instruction specifying G1 as a movement end position, and information such as the velocity, the acceleration, and the deceleration is also transmitted as the transport method. The velocity, the acceleration, and the deceleration may also be preset.

A trapezoidal driving profile for controlling a general carriage is drawn as an acceleration segment, a constant velocity segment, and a deceleration segment, and a movement amount is generally expressed by the following equations (1) to (3). A movement amount x1 of the carriage 40 in the acceleration segment is a segment from time t0 to time t1 in FIG. 10C.

Assuming that x1 represents the movement amount at this time, x1 is expressed by the following equation (1).

$$x 1 = 1 / 2 * v 1 * t 1 \qquad ( 1 )$$

A movement amount x2 of the carriage 40 in the constant velocity segment is a segment from time t1 to time t12 in FIG. 10C. Assuming that x2 represents the movement amount at this time, x2 is expressed by the following equation (2).

$$x 2 = v 1 * ( t 12 - t 1 ) \qquad ( 2 )$$

A movement amount x3 of the carriage 40 in the deceleration segment is a segment from time t12 to time t13 in FIG. 10C. Assuming that x2 represents the movement amount at this time, x2 is expressed by the following equation (3).

$$x 3 = 1 / 2 * v 1 * ( t 13 - t 12 ) \qquad ( 3 )$$

A total movement amount x of the carriage 40 according to the driving profile 200 can be calculated based on the following equation (4) using each of the above-described calculation equations.

$$x = x 1 + x 2 + x 3 \qquad ( 4 )$$

With respect to the driving profile 300 for catching up with the arrival time generated by the original driving profile 200 in the state that the carriage 40 is transported at the second velocity v2 slower than the normal transport velocity because the safe operation instruction is switched to ON, such a driving profile 300 will be described next.

When receiving the safe operation instruction set to OFF from the apparatus control unit 100, the upper-level control unit 10 determines whether the carriage 40 can catch up with the arrival time according to the original driving profile 200 and generates the profile in the generation of the driving profile in step S506.

This will be described citing an example when the safe operation instruction set to OFF is received with the carriage 40 located at the position U1. In the generation of the driving profile in step S506, a provisional driving profile is generated at the timing when the safe operation instruction set to OFF is received.

Because the carriage 40 is located at the position U1 and this corresponds to time t4, the provisional driving profile is the driving profile 300 since time t4.

Before the provisional driving profile is generated, first, a movement amount dx1 of the carriage 40 and a movement amount dx2 remaining to the goal position G1 are calculated. Because the position of the carriage 40 is expressed in the global coordinate system, the movement amounts are calculated using the following equations (5) and (6).

$$dx 1 = U 1 - S 1 \qquad ( 5 )$$

$$dx 2 = G 1 - U 1 \qquad ( 6 )$$

Next, time tdx1 at which the movement amount reaches dx1 in the original driving profile 200 is determined. This requires a calculation of time tdx1 after checking which segment the position of the carriage 40 corresponds to.

When the movement amount dx1<x1, time tdx1 is in the acceleration segment. Time tdx1 in this case is expressed by the following equation (7) from the equation (1).

$$tdx 1 = 2 * dx 1 / v 1 \qquad ( 7 )$$

Similarly, when the movement amount dx1 is x1≤dx1<x1+x2, time tdx1 is in the constant velocity segment, and tdx1 in this case is expressed by the following equation (8).

$$tdx 1 = 2 * dx 1 / v 1 + dx 1 / v 1 \qquad ( 8 )$$

Similarly, when the movement amount dx1 is x1+x2≤dx1, time tdx1 is in the deceleration segment, and tdx1 in this case is expressed by the following equation (9).

$$tdx 1 = 2 * x 1 / v 1 + x 2 / v 1 + 2 * dx 1 / v 1 \qquad ( 9 )$$

Next, time tg when the carriage 40 reaches the position G1 according to the original driving profile 200 is calculated using the following equation (10).

$$tg = 2 * x 1 / v 1 + x 2 / v 1 + 2 * x 3 / v 1 \qquad ( 10 )$$

As a result, time tdx2 for arriving while keeping the originally planned arrival time when moving from the present position U1 to the goal position G1 is calculated using the following equation (11).

$$tdx 2 = tg - tdx 1 \qquad ( 11 )$$

The driving profile 300 is generated using these equations.

Now, assume that the third velocity v3 is a velocity when the transport system 1 transports the carriage 40 at a maximum velocity vmax. A time required for each segment in the trapezoidal velocity profile (driving profile) 300 after the issuance of the safe operation instruction set to OFF is sequentially calculated.

First, a movement time dta1 during an acceleration segment from time t4 to t5 can be calculated using the following equation (12).

$$dta 1 = ( v 3 - v 2 ) / a 1 \qquad ( 12 )$$

Further, a movement amount dxa1 thereof can be calculated using the following equation (13).

$$dxa 1 = 1 / 2 * ( v 2 + v 3 ) * dta 1 \qquad ( 13 )$$

Further, a movement time dta3 during a deceleration segment from time t6 to t7 can be calculated using the following equation (14).

$$dta 3 = v 3 / a 1 \qquad ( 14 )$$

Further, a movement amount dxa3 thereof can be calculated using the following equation (15).

$$dxa 3 = 1 / 2 * v 3 * dta 3 \qquad ( 15 )$$

Accordingly, a movement amount dxa2 in the remaining constant velocity segment can be calculated using the following equation (16).

$$dxa 2 = dx 2 - dxa 1 - dxa 3 \qquad ( 16 )$$

Then, a required time dta2 thereof is calculated using the following equation (17).

$$dta 2 = tdx 2 - dta 1 - dta 3 \qquad ( 17 )$$

Based on these equations, a movement time T since time t4 according to the driving profile 300 is calculated using the following equation (18).

$$T = dta 1 + dta 2 + dta 3 \qquad ( 18 )$$

At this time, it is determined whether the provisional driving profile can catch up with the driving profile 200. If tdx2 is equal to or longer than T, it is determined that the provisional driving profile can catch up with the driving profile 200. However, if tdx2 is shorter than T, it is determined that the provisional driving profile is unable to catch up with the driving profile 200.

At this time, if the provisional driving profile can catch up with the driving profile 200, the driving profile 300 is generated with v3=vmax. When the provisional driving profile can catch up with the driving profile 200, this means that the carriage 40 will arrive earlier than the planned time, raising a possibility of, for example, inflicting contact with the process apparatus 110. Thus, the third velocity v3 should be calculated.

A calculation of an optimum value of the third velocity v3 will now be described. The third velocity v3 that allows time T to match tdx2 needs to be calculated to adjust the third velocity v3 according to the arrival time according to the driving profile 200. The third velocity v3 can be calculated using the following equation (19), which is acquired by transforming the above-described equation.

$$v 3 = v 1 + a 1 * dx 1 / v 1 + v 2 \pm √ ( ( {( v 1 + a 1 * dx 1 + v 2 )}^{2} - 8 a 1 * dxa 2 ) / 4 ) \qquad ( 19 )$$

This allows the optimum third velocity v3 to be calculated, thereby allowing the carriage 40 to be controlled so as to arrive in time to keep the arrival time planned in the original driving profile 200.

In this manner, detecting human intrusion and notifying the transport system 1 thereof as the safe operation instruction allows the transport system 1 to perform control of catching up with the originally intended transport velocity by making up for a delay resulting from changing the velocity to the safe operation velocity in the target range. This allows the present embodiment to suppress a reduction in the production efficiency while taking human safety into consideration.

### Fifth Embodiment

A transport system according to a fifth embodiment of the present disclosure will now be described. The fifth embodiment will be described, assigning the same reference numerals to similar components to the above-described first embodiment, omitting the descriptions thereof as appropriate. The transport system 1 according to the present embodiment is different form the transport system 1 according to the first embodiment in that there is a plurality of carriages 40. The transport system 1 according to the present embodiment is also different from the transport system 1 according to the first embodiment in that the upper-level control unit 10 includes a collision determination unit for detecting and determining a collision between the carriages 40.

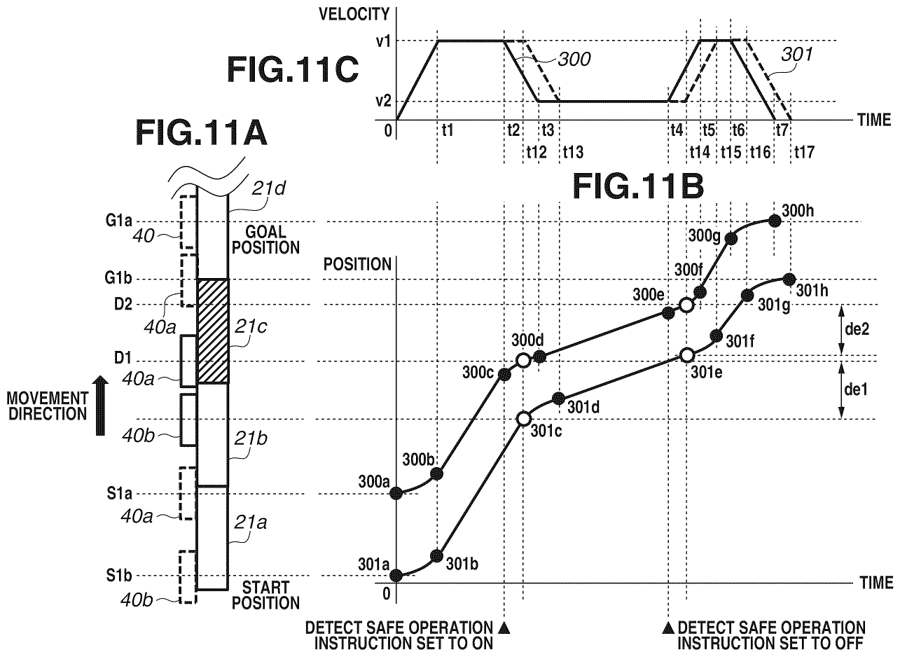

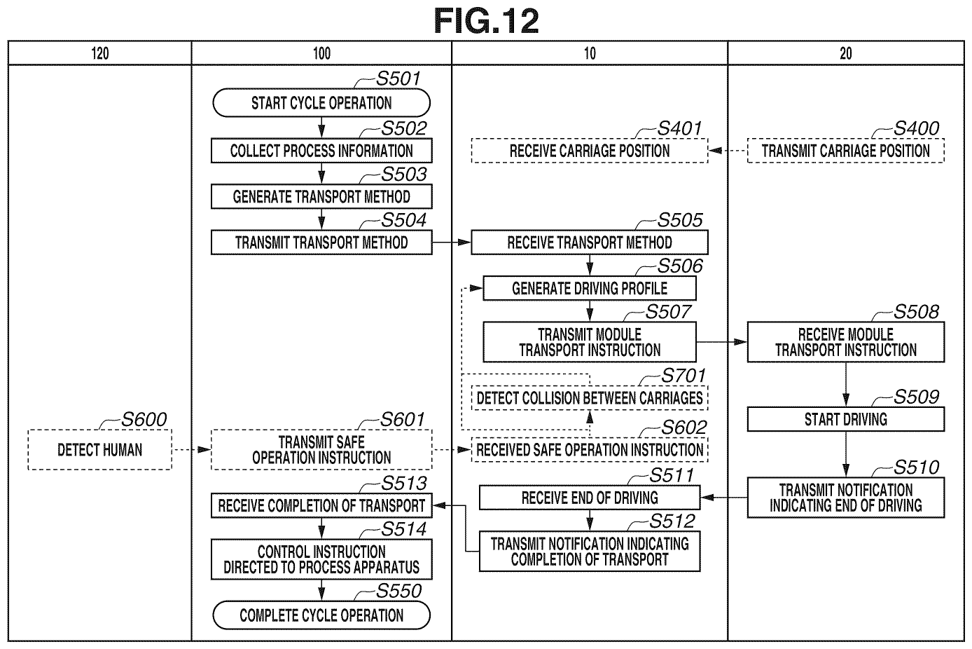

In the following description, the fifth embodiment of the present disclosure will be described with reference to FIGS. 11A to 11C and 12. First, a case in which there is a plurality of carriages 40 will be described with reference to FIGS. 11A to 11C.

When a transport instruction is received from the apparatus control unit 100, the carriages 40 are present at positions as illustrated in FIG. 11A. A carriage 40b (a second mover) is a carriage located behind a carriage 40a (a first mover), i.e., runs on the downstream side of the carriage 40a. The respective start positions of the carriages 40 are represented as Sla for the carriage 40a and S1b for the carriage 40b.

In the present embodiment, assume that an instruction having the same maximum velocity and acceleration is issued from the apparatus control unit 100 to the carriage 40a and the carriage 40b for simplification of the description. At this time, the safe operation instruction is set to OFF. Further, the transport module 21c is represented as the control target directed by the safe operation instruction.

The driving profile 300 illustrated in FIG. 11C is a driving profile with respect to the carriage 40a when the safe operation instruction is switched to ON and then OFF.

A driving profile 301 is a driving profile with respect to the carriage 40b when the safe operation instruction is switched to ON and then OFF.

FIG. 11B illustrates that the safe operation instruction from the apparatus control unit 100 is switched to ON at time t2. Upon receiving the safe operation instruction set to ON, the carriage 40a present on the transport module 21c starts a deceleration operation toward the second velocity v2, which is the transport velocity of the safe operation.

The carriage 40b at this time is not located on the transport module 21 targeted for the safe operation, and therefore is continuously transported at a constant speed.

Next, a case in which the carriage 40a and the carriage 40b approach each other will be described. A predetermined distance value is set in the upper-level control unit 10 as such a distance that a collision may occur if a distance between carriages reaches or falls below this distance.

The carriage 40a is located at a position DI at time t12. At this time, an interval between the carriage 40a and the carriage 40b is de1. This inter-carriage distance de1 is shorter than or equal to the predetermined distance at the timing of time t12.

The upper-level control unit 10 determines that the inter-carriage distance reaches or falls below the predetermined distance, and applies, to the carriage 40b, a maximum velocity and an acceleration lower than or equal to those of the carriage 40a, i.e., a maximum velocity and an acceleration lower than or equal to the second velocity v2. This allows the carriage 40b and the carriage 40a to be transported in a state of maintaining a predetermined or longer distance therebetween after the deceleration is completed.

Next, a reaction when the safe operation instruction is switched to OFF will be described. After the carriage 40a receives the safe operation instruction set to OFF at the timing of time t4, the carriage 40a starts being accelerated toward the original first velocity v1.

Next, velocity recovery of the carriage 40b when the carriage 40a is accelerated and the carriage 40b is transported at the second velocity v2 will be described. In the upper-level control unit 10, a predetermined distance value is set as such a distance that the velocity recovery is conducted if the distance between carriages reaches or exceeds this distance during the safe operation.

The interval between the carriage 40a and the carriage 40b is de2 at the timing of time t14. At this time, the upper-level control unit 10 determines that the inter-carriage distance de2 has reached or exceeded the predetermined distance, and changes the target transport velocity of the carriage 40b to the first velocity v1.

This allows the carriages 40 to be transported according to the safe operation instruction without contact inflicted therebetween.

An inter-carriage collision detection step according to the present embodiment will now be described with reference to FIG. 12. The inter-carriage collision detection step of S701 is a step performed after the safe operation instruction is received from the apparatus control unit 100. In step S701, the interval between the carriages 40 is constantly calculated based on the position information, which is the position information of the carriage 40 acquired asynchronously in step S401, after the safe operation instruction is received.

In the present embodiment, the interval is the interval between the carriage 40a and the carriage 40b, and is calculated based on the central positions of the carriages 40. The central position is used by way of example, but the interval between the carriages 40 may be calculated based on the interval between the side surfaces of the carriages 40 in consideration of the lengths of the carriages 40, and, in this case, a preset threshold value of the inter-carriage distance for deceleration and acceleration may be set according thereto. Further, the preset threshold value is used in the above description, but the threshold value may be instructed for each time as one of the information pieces included in the safe operation instruction issued from the apparatus control unit 100.

In step S506, the driving profile is processed using threshold value information between the carriages 40 according to the safe operation instruction in step S701. This allows the driving profile to be generated while the distance between the carriages 40 is checked with respect to the carriage 40b in step S506.

The present embodiment has been described assuming that the number of carriages 40 is two for simplification of the description, but is not limited thereto and can be applied to a plurality of carriages. The present embodiment can also be implemented in combination with the above-described other embodiments.

In this manner, according to the present embodiment, even a transport system including a plurality of carriages can transport carriages without causing a collision even when a partial safe operation instruction is issued. In other words, the present embodiment allows the velocity to be changed to the safe operation velocity in the target range, thereby being able to suppress a reduction in the production efficiency while taking human safety into consideration.

### OTHER EMBODIMENTS

The technique according to the present disclosure can be modified in various manners without being limited to the above-described embodiments.

For example, each of the above-described embodiments has been described citing the movable magnet type in which the carriage 40 includes the permanent magnet 42 and is driven by the electromagnetic force generated between the permanent magnet 42 and the coil group 23 installed in the transport module 21 by way of example, but is not limited thereto. The transport system may be configured in such a manner that the permanent magnet 42 is provided to the transport module 21 and the coil group 23 is provided to the carriage 40, i.e., configured as a movable coil type.

Further, the transport system according to the present disclosure can be used as a transport system that transports a workpiece together with a carriage to a work area of each process apparatus such as a machine tool that performs each work process on the workpiece that is to be an article in a manufacturing system that manufactures an article such as an electronic device. The process apparatus that performs the work process may be any apparatus such as an apparatus that assembles a component to the workpiece, an apparatus that coats or paints the workpiece, or the like. Further, the manufactured article is not limited to a particular article and may be any component.

Further, the embodiments of the present disclosure also include a control program capable of performing the above-described control method, and a computer-readable recording medium storing the control program. For example, a read only memory (ROM), a disk, an external storage device, or the like may also be used as the recording medium for supplying the control program. More specifically, examples usable as the computer-readable non-transitory recording medium include a flexible disk, an optical disk, a magneto-optical disk, a magnetic tape, a nonvolatile memory such as a universal serial bus (USB) memory, and a solid state drive (SSD).

Further, the present disclosure can also be realized by processing that supplies a program capable of fulfilling one or more functions of the embodiments to a system or an apparatus via a network or a storage medium, and causes one or more processors in a computer of this system or apparatus to read out and execute the program. Further, the present disclosure can also be realized by a circuit (e.g., an application specific integrated circuit (ASIC)) capable of fulfilling one or more functions.

Further, the advantageous effects described in each of the embodiments only indicate an enumeration of most effective advantageous effects brought about from the technique according to the present disclosure, and advantageous effects achievable by the technique according to the present disclosure are not limited to the above-described examples.

The disclosure of the present embodiments includes the following configurations.

### (Item 1)

A transport system including a mover, a transport unit including a plurality of transport modules, a control unit configured to control the mover along the transport unit, a detection unit configured to detect human approach to the transport system, and a setting unit configured to set a velocity of the mover for each of the plurality of transport modules, wherein the setting unit changes the velocity of the mover on at least one of the plurality of transport modules in response to a signal input from the detection unit.

### (Item 2)

The transport system according to Item 1, wherein, in a case where the signal indicating the human approach is input, the setting unit changes the velocity of the mover from a first velocity to a second velocity lower than the first velocity.

### (Item 3)

The transport system according to Item 2, wherein, in a case where the mover is controlled at the second velocity and the signal indicating an end of the human approach is input, the setting unit changes the velocity of the mover to a third velocity higher than the second velocity.

### (Item 4)

The transport system according to Item 3, wherein the third velocity is higher than the first velocity.

### (Item 5)

The transport system according to Item 2, including, as the mover, a first mover and a second mover configured to run on a downstream side of the first mover, wherein, in a case where a velocity of the first mover is the second velocity and a distance between the first mover and the second mover is shorter than or equal to a predetermined distance, the setting unit controls a velocity of the second mover to a velocity lower than or equal to the second velocity.

### (Item 6)

The transport system according to any one of Items 1 to 5, wherein a plurality of detection units is provided in correspondence with the plurality of transport modules, and wherein the setting unit changes the velocity of the mover on the transport module corresponding to the detection unit in response to the signal input from the detection unit.

### (Item 7)

The transport system according to Item 6, wherein the setting unit changes the velocity of the mover on each of two or more transport modules including the transport module corresponding to the detection unit in response to the signal input from the detection unit.

### (Item 8)

The transport system according to Item 6, wherein the setting unit changes the velocity of the mover on a partial section of the transport module corresponding to the detection unit in response to the signal input from the detection unit.

### (Item 9)

The transport system according to any one of Items 1 to 8, wherein one of the transport module and the mover includes a coil, and wherein the other of the transport module and the mover that does not include the coil includes a permanent magnet.

### (Item 10)

The transport system according to any one of Items 1 to 9, wherein the transport unit includes a route in which the mover circulates.

### (Item 11)

A manufacturing system including the transport system according to Item 1, and an apparatus configured to perform work on a workpiece transported by the transport system.

### (Item 12)

A method for controlling a transport system, the transport system including a mover, a transport unit including a plurality of transport modules, and a control unit configured to control the mover along the transport unit, the method including detecting human approach to the transport system; setting a velocity of the mover for each of the transport modules, and changing a velocity of the mover on at least one of the plurality of transport modules in response to a result of the detecting.

### (Item 13)

A method for manufacturing an article, the method including transporting a workpiece included in the article by the control method according to Item 12, and performing work on the workpiece.

### (Item 14)

A computer-readable storage medium storing a program for causing a computer to perform the control method according to claim 12.

According to the present disclosure, a transport system used in a production line involving work by a human can suppress a reduction in production efficiency while taking human safety into consideration.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-054120, which was filed on Mar. 27, 2025 and which is hereby incorporated by reference herein in its entirety.

What is claimed is:

1. A transport system comprising:
a mover;
a transport unit including a plurality of transport modules;
a detection unit configured to detect a human approach the transport system; and
a control unit configured to
control the mover along the transport unit, and
set a velocity of the mover for each of the plurality of transport modules,
wherein the control unit changes the velocity of the mover on at least one of the plurality of transport modules in response to a signal input from the detection unit.

2. The transport system according to claim 1, wherein, in a case where the signal indicating the human approach is input, the control unit changes the velocity of the mover from a first velocity to a second velocity lower than the first velocity.

3. The transport system according to claim 2, wherein, in a case where the mover is controlled at the second velocity and the signal indicating an end of the human approach is input, the control unit changes the velocity of the mover to a third velocity higher than the second velocity.

4. The transport system according to claim 3, wherein the third velocity is higher than the first velocity.

5. The transport system according to claim 2, comprising, as the mover, a first mover and a second mover configured to run on a downstream side of the first mover,
wherein, in a case where a velocity of the first mover is the second velocity and a distance between the first mover and the second mover is shorter than or equal to a predetermined distance, the control unit controls a velocity of the second mover to be a velocity lower than or equal to the second velocity.

6. The transport system according to claim 1, further comprising:
a plurality of detection units that include the detection unit,
wherein the plurality of detection units are provided in correspondence with the plurality of transport modules, and
wherein the control unit changes the velocity of the mover on the transport module corresponding to the detection unit in response to the signal input from the detection unit.

7. The transport system according to claim 6, wherein the control unit changes the velocity of the mover on each of two or more transport modules, of the plurality of transport modules, including the transport module corresponding to the detection unit in response to the signal input from the detection unit.

8. The transport system according to claim 6, wherein the control unit changes the velocity of the mover on a partial section of the transport module corresponding to the detection unit in response to the signal input from the detection unit.

9. The transport system according to claim 1,
wherein the plurality of transport modules or the mover includes a coil, and
wherein the other of the plurality of transport modules and the mover that does not include the coil includes a permanent magnet.

10. The transport system according to claim 1, wherein the transport unit includes a route in which the mover circulates.

11. A manufacturing system comprising:
the transport system according to claim 1; and
an apparatus configured to perform work on a workpiece transported by the transport system.

12. A method for controlling a transport system, the transport system including a mover, a transport unit including a plurality of transport modules, and a control unit configured to control the mover along the transport unit, the method comprising:
detecting a human approach the transport system;
setting a velocity of the mover for each of the plurality of transport modules; and
changing a velocity of the mover on at least one of the plurality of transport modules in response to a result of the detecting.

13. A method for manufacturing an article, the method comprising:
transporting a workpiece included in the article by the control method according to claim 12; and
performing work on the workpiece.

14. A computer-readable storage medium storing computer-executable instructions for causing a computer to perform a control method comprising:
detecting a human approach a transport system, wherein the transport system includes a mover, a transport unit including a plurality of transport modules, and a control unit configured to control the mover along the transport unit;
setting a velocity of the mover for each of the plurality of transport modules; and
changing a velocity of the mover on at least one of the plurality of transport modules in response to a result of the detecting.
